(19) United States
(12) Patent Application Publication
(10) Pub. No.: US 2006/0106123 A1
(43) Pub. Date: May 18, 2006

(54) Composition comprising an elastomeric polymer and an olefinic polymer

(75) Inventor: Minoru Hatta, HONCHO (JP)

Correspondence Address: MAYER, BROWN, ROWE & MAW LLP, 1909 K STREET, N.W., WASHINGTON, DC, 20006, US

(73) Assignee: DSM IP ASSETS B.V., TE HEERLEN (NL)

(21) Appl. No.: 10/521,407

(22) PCT Filed: Jul. 11, 2003
(86) PCT No.: PCT/NL03/00511

§ 371 Date: Aug. 23, 2005

(30) Foreign Application Priority Data
Jul. 18, 2002 (EP) 02102042.5

(51) Int. Cl. C08J 9/00

(52) U.S. Cl. 521/134

(57) ABSTRACT

Foamed composition comprising: 100 parts by weight elastomeric polymer (A), comprising monomeric units of ethylene and an α-olefin, 1-50 parts by weight olefinic polymer (B), and further comprising 98-65 weight % monomeric units of ethylene; and 2-35 weight % monomeric units of an alpha-olefin having 4-12 carbon atoms, polymer B having a density of 880-915 kg/m³. The composition shows a very good foam structure.

The invention relates to a foamed composition comprising an elastomeric polymer.

Foamed compositions comprising an elastomeric polymer, for example an ethylene-propylene elastomeric polymer or an ethylene-propylene-polyene elastomeric polymer are known.

The composition is known in various densities. The density, which depends on the degree of foaming of the composition may vary from very low densities of about 50 kg/m³, or even lower, to densities approaching the density of the solid, so unfoamed, composition.

In the low density area the composition is used for example as isolation material. A good example is the use of such a composition in isolation hoses to cover hot water transport pipes of a central heating system or an isolation hose to cover the transport hose of an automotive coolant system.

A typical example in the high-density area are so-called micro-porous weather profiles. Such profiles are for example used in automobiles and buildings, to seal windows and doors. The composition is slightly foamed, so that the profile is reduced in weight, but still shows good mechanical properties. Weight reduction is especially favourable for automobiles as there is a continuous need to decrease the weight of automobiles. Further the objects of such a slightly foamed composition comprise less of the elastomeric polymer, so that a cost reduction is obtained.

A disadvantage of the known composition however is that the structure of the foamed composition is unsatisfactory.

Object of the invention is to provide a foamed composition comprising an elastomeric polymer having an improved structure.

Surprisingly this object is achieved by a foamed composition, comprising:

A. 100 parts by weight elastomeric polymer, comprising monomeric units of ethylene and an α-olefin,

B. 1-50 parts by weight olefinic polymer, comprising:

b1. 98-65 weight % monomeric units of ethylene

b2. 2-35 weight % monomeric units of an alpha-olefin having 4-12 carbon atoms.

In the high-density area objects of the foamed composition are obtained showing a smooth surface.

A further advantage is that foamed composition according to the invention shows good mechanical properties, especially good ultimate properties, for example tear strength, elongation at break. Further the composition shows a good processability, and favourable values for the compressions set. For the slightly foamed composition the mechanical properties are almost at the level of the original, unfoamed composition. This is important for the used of the composition in for instance extruded profiles for the building & construction market and the automotive market.

In the low-density area an isolation material is obtained having a homogeneous structure of cells of a small diameter.

It is possible that the elastomeric polymer (A) is obtained by the polymerisation of ethylene of and an α-olefin, so that it essentially consists of monomeric units of ethylene and the α-olefin (EPM). As α-olefin an α-olefin with 3-10 carbon atoms can for instance be used; examples are propylene, butylene, hexene, octene etc. Preferably, propylene is used.

Preferably as the elastomeric polymer (A) a polymer is used comprising monomeric units of ethylene, an α-olefin and a non-conjugated polyene (EPDM), because this elastomer can be vulcanised in conventional curing equipment.

As α-olefin is used for instance an α-olefin with 3-10 carbon atoms; examples are propylene, butylene, hexene, octene etc. Preferably, propylene is used.

The ethylene to α-olefin weight ratio in elastomeric polymer (A) may be between 90/10 and 20/80. Preferably, the ethylene to α-olefin weight ratio is between 70/30 and 40/60, more preferably the weight ratio is in between 60/40 and 40/60.

Examples of non-conjugated polyenes to be applied in the elastomeric polymer (A) are 5-ethylidene-2-norbornene, 5-vinyl-2-norbornene, dicyclopentadiene, 1,4 hexadiene or mixtures thereof. Preferably the elastomeric polymer (A) comprises 5-ethylidene-2-norbornene.

The non-conjugated polyene may be present in the elastomeric polymer in a amounts of 3-35 weight %, preferably 4-15 weight %. The preparation of elastomeric polymer (A) is known to the person skilled in the art. The polymer can for instance be prepared by polymerization with the help of a Ziegler-Natta catalyst or a metallocene catalyst.

The olefinic polymer (B) preferably comprises as monomeric units of the α-olefin, monomeric units of butylene, hexene or octene. Most preferably the olefinic polymer (B) comprises monomeric units of ethylene and octene.

The olefinic polymer (B) preferably comprises 95-70 weight % monomeric units of ethylene and 5-30 weight % monomeric units of the α-olefin, more preferably the olefinic polymer (B) comprises 90-75 weight % monomeric units of ethylene and 10-25 weight % monomeric units of the α-olefin.

The olefinic polymer (B) may have a density of 880-915 kilograms per cubic meter (kg/m³). Preferably the polymer has a density of 880-905 kg/m³, more preferably 880-900 kg/m³, still more preferably of 880-895 kg/m³.

The olefinic polymer (B) preferably has a melt peak temperature as measured by DSC of at most 110° C., more preferably at most 105° C. Still more preferably the olefinic polymer (B) has a melt peak temperature as measured by DSC between 50-105° C., even more preferably between 60-95° C., most preferably between 65 and 88° C. The degree of crystallinity, as measured by DSC, preferably is <25, more preferably <20%, most preferably <15%.

Preferably the olefinic polymer (B) is produced by a single site catalyst, most preferably by a metallocene catalyst. Examples of suitable metallocene catalysts for the production of the olefinic polymer include compounds according to formula II:
MLₓ form. II

In formula II, M is a transition metal selected from group IVB of the periodic table, specifically zirconium, titanium or hafnium, and L is a ligand coordinated to the transition metal. Al least one ligand L is having a cyclopentadienyl skeleton.

As the single site catalyst, especially the metallocene catalyst, readily incorporates monomeric units of the α-olefin with the monomeric units of ethylene in the olefinic polymer (B), the monomeric units of the α-olefin are uniformly and randomly distributed along the polymer chain of the olefinic polymer (B), as opposed to conventional olefinic copolymers. For this reason the olefinic polymer (B) produced by these catalysts tend to show a narrow molecular weight distribution and a narrow melting temperature range.

If a polymer (B) is used that is produced by a single site catalyst, especially a metallocene catalyst, an even higher strain release is obtained in the shaped object.

The amount of olefinic polymer (B) in the composition according to the invention may be 1 to 50 parts by weight to every 100 parts by weight of elastomeric polymer (A), preferably 5 to 45 parts by weight, more preferably 10-40 parts by weight, most preferably 14-35 parts by weight.

Preferably an elastomeric polymer (A) is used having a crystallinity of at most 5%, measured by means of DSC (differential scanning calorimetry), at room temperature and higher temperatures. Room temperature is defined as being 23° C.

In this way a foamed composition is obtained having very good elastic properties at low temperatures, like compression set. Further the composition has a low elastic memory, which means that the composition, quickly takes back its original shape after a deformation. This is also true if the composition is unvulcanized, of course than in comparison with other unvulcanized composition according to the state of the art. This all is true for both the foamed and unfoamed composition.

Therefore the invention also relates to a composition comprising:

A. 100 parts by weight elastomeric polymer, comprising monomeric units of ethylene and an α-olefin, having a crystallinity of at most 5%.

B. 1-50 parts by weight olefinic polymer, comprising:

b1. 98-65 weight % monomeric units of ethylene

b2. 2-35 weight % monomeric units of an alpha-olefin having 4-12 carbon atoms.

Preferably the copolymer (A) has a crystallinity of at most 1%, more preferably the copolymer has no crystallinity above 23° C. Such a composition shows a still further improved processability, which is for instance important if objects with complicated geometry are extruded. Even more preferably, the copolymer has no crystallinity above 0° C. The crystallinity is determined from a DSC experiment, in which a polymer sample is heated at a rate of 20° C./minute to 200° C., is kept at that temperature for 5 minutes and is cooled down to −70° C. at a rate of 5° C./minute. The thermal effects that than occur are recorded. The %-crystallinity is calculated from the crystallization enthalpy (ΔH, J/g sample) according to the formula:
%-crystallinity=ΔH/2.94 (XI)

Very good results are obtained if an elastomeric polymer (A) is used comprising monomer units of a) ethylene, b) an α-olefin, c) a non-conjugated polyene (C) which in the molecule contains one C═C bond that is polymerizable using a Ziegler-Natta catalyst, and d) optionally a non-conjugated polyene (D) which in the molecule contains two or more C═C bonds, that are polymerizable using a Ziegler-Natta catalyst, which elastomeric polymer (A) is obtainable by a process wherein it is polymerized by means of a catalyst composition comprising a Group 3, 4, 5 or 6 transition metal compound and a Group 1, 2, 12 or 13 organometallic compound and a compound represented by the formula: 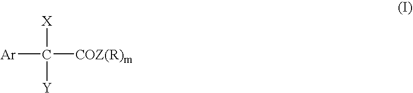
where:
X=a halogen atom,
Y=H, an alkyl group with 1-30 C atoms, an aromatic group with 6-30 C-atoms, or a halogen atom,
Z=O (oxygen) or N (nitrogen),
R independently represents H, an alkyl group with 1-30 C atoms or an aromatic group with 6-30 C atoms,
Ar=an aromatic group with 6-30 C atoms
m=1 or 2.

Such process is described in more detail in WO-98/00369.

Good examples of polyenes (C) are 5-ethylidene-2-norbornene and 1,4 hexadiene. Good examples of polyenes (D) are 5-vinyl-2-norbornene and dicyclopentadiene.

The polyene (C) may be present in an amount of 3-30 weight %, preferably 4-15 weight %. The polyene (D) may be present in an amount of 0.1-5 weight %, preferably 0.2-2 weight %.

A very suitable compound according to form. I is the ethyl ester of monochlorodiphenyl acetic acid.

The transition metal compound used in the catalyst composition preferably is VCl₄, VCl₃, VCl₃.3THF (with THF being a tetrahydrofuran group). The organometallic compound preferably is triethyl aluminium, triisobutyl aluminium, trioctyl aluminium, diethyl aluminium ethoxide, diisobutyl aluminium chloride, dimethyl aluminium chloride, diethyl aluminium chloride, methyl aluminium dichloride, ethyl aluminium dichloride, isobutyl aluminium dichloride, isobutyl aluminium sesquichloride, or ethyl aluminium sesquichloride. Most preferably the organometallic compound is diethyl aluminium chloride and ethyl aluminium sesquichloride.

Preferably the polyenes (C) and (D) are present in such an amount that the copolymer A satisfying the relationship:
Mw/Mn<−0.066.Δδ+a (1)
where:
Mw is the weight-average molecular weight of the copolymer,
Mn is the number-average molecular weight of the polymer,
a=4.8

Δδ is, expressed in degrees, the difference between the loss angle δ at a frequency of 0.1 rad/s and the loss angle δ at a frequency of 100 rad/s, whereby the loss angle is calculated from the formulae tgδ=G″/G′, whereby G′ is the storage modulus and G″ is the loss modulus, as measured by mechanical dynamic analysis at a temperature of 125° C. (suitable equipment for the measurement of the moduli is a Rheometrics™ Dynamical Analyzer).

Preferably a=4.5, more preferably a=4.3, and more preferably a=4.1.

Δδ from formula 1 and the method for measuring it has been introduced by H. C. Booij, Kautschuk Gummi Kunststoffe 44, 128 (1991).

For the foaming of the foamed composition according to the invention most often a chemical blowing agent is used. Good examples of suitable blowing agents are diazene dicarbonamide (ADC), p,p′-oxy-bis(benzenesulfonyl)hydrazide (o-BSH) and dinitosopentamethylenetetramine (DPT).

Conventional equipment and process conditions may be used for the foaming of the composition according to the invention, well known to the person skilled in the art.

Besides the elastomeric polymer (A) and the olefinic polymer (B) the composition according to the invention may comprise usual additives. The composition may comprise carbon black in an amount of 20-400, preferably 40-200 parts by weight relative to 100 parts by weight elastomeric polymer. Also alternative reinforcement agents like silica may be used.

The composition may comprise one or more extenders, for example in an amount of 10 to 300 parts by weight, preferably 20-100 parts by weight, more preferably 40-80 parts by weight relative to 100 parts by weight of the elastomeric polymer. Examples of extenders are calcium carbonate and clay.

The composition may comprise oil in an amount of for example 20.

Preferably the polyenes (C) and (D) are present in such an amount that the copolymer A satisfying the relationship:
Mw/Mn<−0.066.Δδ+a (1)
where:
Mw is the weight-average molecular weight of the copolymer,
Mn is the number-average molecular weight of the polymer,
a=4.8

Δδ is, expressed in degrees, the difference between the loss angle δ at a frequency of 0.1 rad/s and the loss angle δ at a frequency of 100 rad/s, whereby the loss angle is calculated from the formulae tgδ=G″/G′, whereby G′ is the storage modulus and G″ is the loss modulus, as measured by mechanical dynamic analysis at a temperature of 125° C. (suitable equipment for the measurement of the moduli is a Rheometrics™ Dynamical Analyzer).

Preferably a=4.5, more preferably a=4.3, and more preferably a=4.1.

Δδ from formula 1 and the method for measuring it has been introduced by H. C. Booij, Kautschuk Gummi Kunststoffe 44, 128 (1991).

For the foaming of the foamed composition according to the invention most often a chemical blowing agent is used. Good examples of suitable blowing agents are diazene dicarbonamide (ADC), p,p′-oxy-bis(benzenesulfonyl)hydrazide (o-BSH) and dinitosopentamethylenetetramine (DPT).

Conventional equipment and process conditions may be used for the foaming of the composition according to the invention, well known to the person skilled in the art.

Besides the elastomeric polymer (A) and the olefinic polymer (B) the composition according to the invention may comprise usual additives. The composition may comprise carbon black in an amount of 20-400, preferably 40-200 parts by weight relative to 100 parts by weight elastomeric polymer. Also alternative reinforcement agents like silica may be used.

The composition may comprise one or more extenders, for example in an amount of 10 to 300 parts by weight, preferably 20-100 parts by weight, more preferably 40-80 parts by weight relative to 100 parts by weight of the elastomeric polymer. Examples of extenders are calcium carbonate and clay.

The composition may comprise oil in an amount of for example 20.

### EXAMPLES AND COMPARATIVE EXAMPLES

### Example 1 and Comparative Experiments A and B

Compositions comprising EPDM and no further resin (comparative experiment A), EPDM and LDPE (comparative experiment B) and EPDM and plastomer, according to the invention (example 1) are given in Table 1.

The compositions were blended in a total quantity of 4.5 kg each in a 5.6 liter Banbury mixer. The mixing time was 5 minutes, the temperature of the composition at the end of the mixing cycle in the Banbury mixer was 140° C. After that the composition was rolled on a two roll mill for 3 minutes. The surface temperature of the two roll mill was 40° C.

The mixture was taken from the two roll mill and compression moulded into a 2 mm thick sheet. During the compression moulding the elastomer was cured. Samples were taken from the cured sheet for measurement of the mechanical properties. The results are shown in Table 2. The difference in properties as measured for the example and the comparative experiments was taken as representative for the difference observable for the same compositions in a slightly foamed state.

TABLE 1
compositions according to comparative experiments A and B
and example 1.

| | comp. | comp. | |
|---|---|---|---|
| | exp. A | exp. B | example 1 |
| K2340A (EPDM 1) | 40 | 40 | 40 |
| K8340A (EPDM 2) | 60 | 60 | 60 |
| Sumikasen G807 (LDPE) | 0 | 20 | 0 |
| EXACT0201 (C2/C8 | 0 | 0 | 20 |
| copolymer, | | | |
| density 902 kg/m2) | | | |
| Active ZnO | 5 | 5 | 5 |
| Carbon Black | 100 | 100 | 100 |
| CaCO3 | 40 | 40 | 40 |
| Stearic acid | 2 | 2 | 2 |
| PS430 | 60 | 60 | 60 |
| CaO | 8 | 8 | 8 |
| Accelerator | 5.75 | 5.75 | 5.75 |
| S (sulfur) | 0.60 | 0.60 | 0.60 |
| Total PHR | 321.35 | 341.35 | 341.35 |

TABLE 2
results comparative experiments A and B and example 1.

| | | comp. | comp. | |
|---|---|---|---|---|
| | | exp. A | exp. B | example 1 |
| TR | (N/mm) | 40.0 | 42.0 | 47.0 |
| TB | (Mpa) | 12.5 | 12.0 | 13.5 |
| EB | (%) | 360 | 390 | 430 |
| M[100%] | (Mpa) | 3.3 | 3.5 | 3.6 |
| M[300%] | (Mpa) | 10.5 | 9.2 | 9.7 |
| Hs | (JIS-A) | 66 | 72 | 72 |
| Density | | 1.21 | 1.19 | 1.19 |

| Compression set | | | | | |
|---|---|---|---|---|---|
| 100° C. | 70 hr | 25% | 56 | 63 | 58 |
| −20° C. | 22 hr | 25% | 32 | 50 | 47 |

TR is tear strength, TB is tensile strength at break, EB is elongation at break, M{100%] is modulus at a deformation of 100%.

From the results it is clear that the mechanical properties of the composition according to the invention comprising EPDM and the C2/C8 copolymer are better than those of the comparative experiments. This is especially true for the ultimate properties like elongation at break, the tear strength and the compression set as measured at 100 and −20° C.

### Example 2 and Comparative Experiments C and D

The compositions of experiment 1, comparative experiment A and comparative experiment B to which compositions a small amount of a state of the art foaming agent is added are foamed. A single screw extruder having a diameter of 25 mm is used at a screw speed of 25 rpm. A slit die is used of 20 mm width and 2 mm height. The extrusion temperature is 80° C. The slightly foamed strip extruded in this way is cured at a temperature of 210° C.

The surface of the strip of the composition according to the invention shows a very smooth surface, whereas the strips according to the comparative experiments C and D are less smooth.

### Example 3

A composition according to the invention as presented in Table 3 was prepared according to the procedure of example 1 and extruded by the same extruder as used in example 2.

TABLE 3

| | |
|---|---|
| Keltan 509X100 (EPDM) | 40 |
| Keltan 4703 (EPDM) | 80 |
| EXACT8201 (C2/C8 copolymer, density 882 kg/m2) | 20 |
| ZnO (No. 1) | 10 |
| Stearic | 2 |
| Carbon black | 65 |
| CaCO3 | 40 |
| Processing aid | 4 |
| Paraffinic oil (PS430) | 38 |
| CaO | 8 |
| S-cure system | 6.75 |
| DPT (foaming agent) | 10.00 |
| Urea | 8.00 |
| Total PHR | 331.8 |

The water take up of the foam was determined by putting a foamed strip having a length of 100 mm, obtained from the extrusion process, in a vessel filled with water, so that the strip is fully covered with water. The vessel was evacuated to a pressure of 130 mm Hg for 3 minutes. The temperature was 20° C. The weight of the water take up in the foam was measured by weighing the strip before and after it was put in the vessel.

The foam properties are presented in Table 4. It is shown that at a low density the foam has a very low water pick up. This shows that the foam has a well developed skin and closed cells, which is favorable for use in sponge.

TABLE 4
Properties foam example 3.

| | |
|---|---|
| Density | 0.17 |
| Absorption rate (%) | 0.952 |

1. Foamed composition comprising:
100 parts by weight elastomeric polymer (A), comprising monomeric units of ethylene and an α-olefin,
1-50 parts by weight olefinic polymer (B), comprising:
b1. 98-65 weight % monomeric units of ethylene
b2. 2-35 weight % monomeric units of an alpha-olefin having 4-12 carbon atoms, polymer B having a density of 880-915 kg/m³.

2. Foamed composition according to claim 1, wherein as the elastomeric polymer (A) a polymer is used comprising monomeric units of ethylene, an α-olefin and a non-conjugated polyene (EPDM).

3. Composition comprising:
100 parts by weight elastomeric polymer (A), comprising monomeric units of ethylene and an α-olefin, having a crystallinity of at most 5%,
1-50 parts by weight olefinic polymer (B), comprising:
b1. 98-65 weight % monomeric units of ethylene
b2. 2-35 weight % monomeric units of an alpha-olefin having 4-12 carbon atoms, polymer B having a density of 880-915 kg/m³.

4. Composition according to claim 2, wherein a polymer (A) is used comprising monomer units of a) ethylene, b) an α-olefin, c) a non-conjugated polyene (C) which in the molecule contains one C═C bond that is polymerizable using a Ziegler-Natta catalyst, and d) optionally a non-conjugated polyene (D) which in the molecule contains two or more C═C bonds, that are polymerizable using a Ziegler-Natta catalyst, which polymer (A) is obtainable by a process wherein it is polymerized by means of a catalyst composition comprising a Group 3, 4, 5 or 6 transition metal compound and a Group 1, 2, 12 or 13 organometallic compound and a compound represented by the formula: 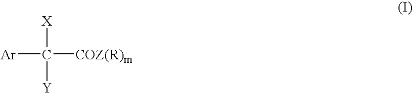
where:
X=a halogen atom,
Y=H, an alkyl group with 1-30 C atoms, an aromatic group with 6-30 C-atoms, or a halogen atom,
Z=O (oxygen) or N (nitrogen),
R independently represents H, an alkyl group with 1-30 C atoms or an aromatic group with 6-30 C atoms,
Ar=an aromatic group with 6-30 C atoms, and
m=1 or 2.

5. Foamed composition according to claim 1, wherein olefinic polymer (B) has a density of 880-905 kg/m³.

6. Foamed composition according to claim 1, wherein olefinic polymer (B) has a density of 880-895 kg/m³.

7. Foamed composition according to claim 1, wherein olefinic polymer (B) is produced by a single site catalyst.

8. Preblend comprising:
100 parts by weight elastomeric polymer (A) and
1-50 parts by weight olefinic polymer (B).

9. Preblend according to claim 8 in the form of a rubber bale or granulate.

10. Preblend according to claim 8, wherein the sum of elastomeric polymer (A) and olefinic polymer (B) in the preblend at least adds up to 75 weight %.

11. A compounding process using the preblend of claim 10.

12. Preblend according to claim 9, wherein the sum of elastomeric polymer (A) and olefinic polymer (B) in the preblend at least adds up to 75 weight %.

13. Composition according to claim 3, wherein a polymer (A) is used comprising monomer units of a) ethylene, b) an α-olefin, c) a non-conjugated polyene (C) which in the molecule contains one C═C bond that is polymerizable using a Ziegler-Natta catalyst, and d) optionally a non-conjugated polyene (D) which in the molecule contains two or more C═C bonds, that are polymerizable using a Ziegler-Natta catalyst, which polymer (A) is obtainable by a process wherein it is polymerized by means of a catalyst composition comprising a Group 3, 4, 5 or 6 transition metal compound and a Group 1, 2, 12 or 13 organometallic compound and a compound represented by the formula: 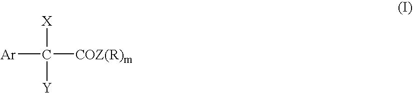
where:
X=a halogen atom,
Y=H, an alkyl group with 1-30 C atoms, an aromatic group with 6-30 C-atoms, or a halogen atom,
Z=O (oxygen) or N (nitrogen),
R independently represents H, an alkyl group with 1-30 C atoms or an aromatic group with 6-30 C atoms,
Ar=an aromatic group with 6-30 C atoms, and
m=1 or 2.

14. Composition according to claim 3, wherein olefinic polymer (B) has a density of 880-905 kg/m³.

15. Foamed composition according to claim 7, wherein the single site catalyst comprises a metallocene catalyst.

16. Composition according to claim 3, wherein olefin polymer (B) is produced by a single site catalyst.

17. Composition according to claim 16, wherein the single site catalyst comprises a metallocene catalyst.
